(19) United States
(12) Patent Application Publication
(10) Pub. No.: US 2017/0340114 A1
(43) Pub. Date: Nov. 30, 2017

(54) NON-BOLTED PIPE FITTING BRACKET

(71) Applicants: Chun Soon CHOI, Seoul (KR); Kyong Bae KIM, Seoul (KR); Oh Seo KWON, Gyeonggi-do (KR)

(72) Inventors: Chun Soon CHOI, Seoul (KR); Kyong Bae KIM, Seoul (KR); Oh Seo KWON, Gyeonggi-do (KR)

(21) Appl. No.: 15/608,531

(22) Filed: May 30, 2017

(30) Foreign Application Priority Data
May 30, 2016 (KR) 10-2016-0066187

(51) Int. Cl. A47B 96/06; A47F 5/10; A47B 47/00; A47B 96/14; F16M 13/02; A47F 5/13

(52) U.S. Cl. CPC A47B 96/067; F16M 13/025; A47F 5/13; A47B 47/00; A47B 96/1433; A47B 96/1408; A47F 5/101

(57) ABSTRACT

A non-bolted pipe fitting bracket for assembling an assembled pipe for displaying and preserving an article without using a bolt and a nut includes: a bracket that is a support unit, in which a pair of side surface support bodies are assembled at the right angle at corners of horizontal pipes each having a pair of horizontal stopping holes and a vertical pipe having a pair of vertical stopping holes, horizontal stopping steps are formed at upper ends of the side surface support bodies to be coupled to the horizontal stopping holes, and vertical stopping steps are formed on side surfaces of the side surface support bodies to be coupled to the vertical stopping holes.

### CROSS REFERENCE

This application claims priority of Korean Patent Application No. 10-2016-0066187 filed 30 May 2016, with the Korean Intellectual Property Office, each of which is hereby incorporated by reference in its entirety.

### BACKGROUND

The present invention relates to relates to a non-bolted pipe fitting bracket, and more particularly, relates to a non-bolted pipe fitting bracket that provides structural safety and firmness, simplicity and convenience for assembling, and various structural utilizations and applications to satisfy various needs of consumers who are users of a bracket product and give good images to the consumers by remarkably improving the quality and reliability of the bracket product.

As well known, assembly shelves (angle irons) are structures that are assembled such that products for sales may be displayed in warehouses, supermarkets, discount stores, and other stores, or articles may be laid and preserved on the assembly shelves (angle irons).

The assembly shelves (angle irons) are widely used because it may effectively display and exhibit various products so that the consumers may easily choose and select various products, may be installed relatively simply, and may be easily disassembled.

Generally, an assembly shelf (angle iron) includes vertical members that stand uprights in a rectangular frame disposition structure, and horizontal members connected to the vertical members to transversely cross between the vertical members, and is assembled by coupling bolts and nuts through holes formed in the vertical members and the horizontal members.

However, the assembly shelf (angle iron) using bolts and nuts requires very complex assembling operations and much time, and in particular, the bolts and the nuts have to be loosened one by one during a disassembling operation.

Meanwhile, although an assembly shelf (angle iron) in which rivets are attached to side surfaces of horizontal members, fitting holes corresponding to the rivets are formed on side surfaces of the vertical members, and the vertical members and the horizontal members are assembled has been suggested, this also requires a complex process for the horizontal members, such as an operation of attaching the rivets to the side surfaces of the horizontal members and the fitting method using rivets has a disadvantage of weak coupling force and loosening, which are disadvantageous in a practical aspect.

In this regard, in recent years, non-bolted shelves (angle irons) that do employ neither a bolt nor a nut have been widely used.

However, the assembly shelf frames are assembled such that the horizontal members coupled to the vertical members are interference-fitted with the vertical members so as not to be shaken to the left and right sides, and because the operator inserts stoppers of the horizontal members into coupling slots of the vertical members for interference fitting and then, in this state, presses down the horizontal members with a specific force, the horizontal members cannot be easily coupled to the vertical members.

Further, when the horizontal members and the vertical members are frequently assembled and disassembled, the coupling force deteriorates as the coupling slots and the stoppers formed in the members are worn out, and accordingly, the coupling portions of the members are shaken to the left and right sides, deteriorating the structural stability.

In addition, the conventional technology cannot provide structural stability and firmness, simplicity and convenience for assembling, and various structural utilizations and applications.

The following prior documents were filed to solve the above-mentioned problems, but all the problems cannot still be solved at the same time.

### SUMMARY OF THE INVENTION

The present invention has been made in an effort to solve the above-mentioned problems, and provides a non-bolted pipe fitting bracket. The first object of the present invention is to integrally form a pair of side support bodies on opposite surfaces of a central support body and provide a bracket that is a support unit, which has a horizontal stopping step on a horizontal surface thereof and a vertical stopping step on a vertical surface thereof. The second object of the present invention is to simply assemble assembled pipes for displaying and preserving various articles without using a bolt and a nut. The third object of the present invention is to firmly assemble a pipe without welding. The fourth object of the present invention is to provide structural stability and firmness. The fifth object of the present invention is to provide simplicity and convenience for assembling. The sixth object of the present invention is to provide utility and applications for various structures. The seventh object of the present invention is to provide a stable structure that becomes more stable without causing shaking as a higher load is applied to the structure in a Morse taper method. The eighth object of the present invention is to satisfy various needs of consumers who are users to give good images to the consumers by remarkably improving the quality and reliability of a bracket product accordingly.

In accordance with an aspect of the present invention, there is provided a non-bolted pipe fitting bracket for simply assembling an assembled pipe for displaying and preserving an article without using a bolt and a nut, the non-bolted pipe fitting bracket including: a bracket that is a support unit, in which a pair of side surface support bodies are assembled at the right angle at corners of horizontal pipes each having a pair of horizontal stopping holes and a vertical pipe having a pair of vertical stopping holes, horizontal stopping steps are formed at upper ends of the side surface support bodies to be coupled to the horizontal stopping holes, and vertical stopping steps are formed on side surfaces of the side surface support bodies to be coupled to the vertical stopping holes.

As discussed above in detail, the present invention may integrally form a pair of side support bodies on opposite surfaces of a central support body and provide a bracket that is a support unit, which has a horizontal stopping step on a horizontal surface thereof and a vertical stopping step on a vertical surface thereof.

The present invention may simply assemble assembled pipes for displaying and preserving various articles without using a bolt and a nut.

The present invention may firmly assemble a pipe without welding.

The present invention may provide structural stability and firmness.

The present invention may provide simplicity and convenience for assembling.

The present invention may provide utility and applications for various structures.

The present invention may provide a stable structure that becomes more stable without causing shaking as a higher load is applied to the structure in a Morse taper method.

The present invention may satisfy various needs of consumers who are users to give good images to the consumers by remarkably improving the quality and reliability of a bracket product accordingly.

### BRIEF DESCRIPTION OF THE DRAWINGS

Hereinafter, exemplary embodiments of the present invention for achieving the effects will be described in detail with reference to the accompanying drawings.

FIG. 1 is a perspective view of a non-bolted pipe fitting bracket according to a first embodiment of the present invention;

FIG. 2 is an exploded perspective view of the non-bolted pipe fitting bracket according to the first embodiment of the present invention before the non-bolted pipe fitting bracket is coupled to a pipe;

FIG. 3 is a perspective view of the non-bolted pipe fitting bracket according to the first embodiment of the present invention after the non-bolted pipe fitting bracket is coupled to the pipe;

FIG. 4 is a sectional view of the non-bolted pipe fitting bracket according to the first embodiment of the present invention after the non-bolted pipe fitting bracket is coupled to the pipe;

FIG. 5 is a perspective view of a non-bolted pipe fitting bracket according to a second embodiment of the present invention;

FIG. 6 is an exploded perspective view of the non-bolted pipe fitting bracket according to the second embodiment of the present invention before the non-bolted pipe fitting bracket is coupled to a pipe;

FIG. 7 is a perspective view of the non-bolted pipe fitting bracket according to the second embodiment of the present invention after the non-bolted pipe fitting bracket is coupled to the pipe;

FIG. 8 is a sectional view of the non-bolted pipe fitting bracket according to the second embodiment of the present invention after the non-bolted pipe fitting bracket is coupled to the pipe;

FIG. 9 is a perspective view of a non-bolted pipe fitting bracket according to a third embodiment of the present invention;

FIG. 10 is an exploded perspective view of the non-bolted pipe fitting bracket according to the third embodiment of the present invention before the non-bolted pipe fitting bracket is coupled to a pipe;

FIG. 11 is a perspective view of the non-bolted pipe fitting bracket according to the third embodiment of the present invention after the non-bolted pipe fitting bracket is coupled to the pipe; and

FIG. 12 is a sectional view of the non-bolted pipe fitting bracket according to the third embodiment of the present invention after the non-bolted pipe fitting bracket is coupled to the pipe.

### DETAILED DESCRIPTION OF THE INVENTION

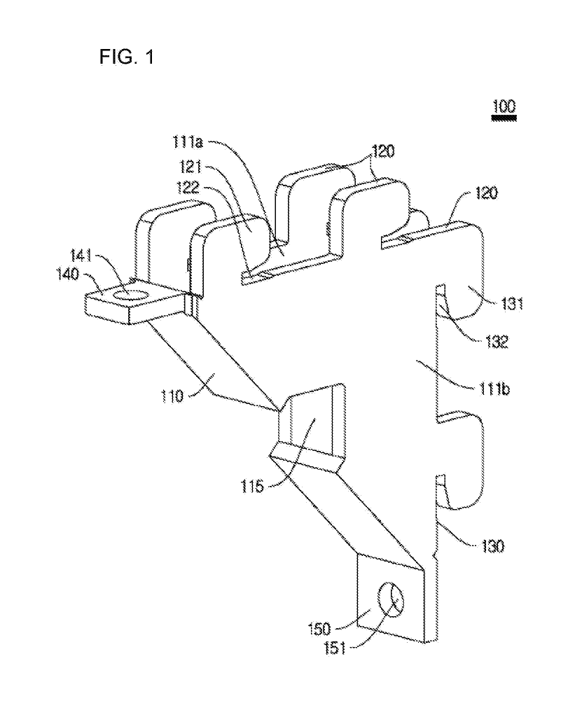

A non-bolted pipe fitting bracket according to the present invention is constituted as illustrated in FIGS. 1 to 12.

In a description of the present invention, a detailed description of related known functions and configurations will be omitted when it may make the essence of the present invention unnecessarily obscure.

Further, the following terms are terms set in consideration of their functions in the present invention and may become different according to intentions and customs of manufacturers, their definitions should be made based on the contents in the entire specification.

Further, because the sizes and thicknesses of the elements of the drawings are specified for convenience of description, the present invention is not necessarily limited to the drawings.

First, the present invention includes a bracket 100 (a first embodiment), 100a (a second embodiment), and 100b (a third embodiment) that corresponds to a support unit to simply assemble an assembled pipe for displaying and preserving various articles without using a bolt and a nut.

That is, the present invention provides a non-bolted pipe fitting bracket including a bracket 100 that is a first support unit, a bracket 110a that is a second support unit, or a bracket 100b that is a third support unit in which a pair of side surface support bodies 111a and 111b are assembled at the right angle at corners of horizontal pipes 10 each having a pair of horizontal stopping holes 11 and a vertical pipe 20 having a pair of vertical stopping holes 21, horizontal stopping steps 121 are formed at upper ends of the side surface support bodies 111a and 111b to be coupled to the horizontal stopping holes 11, and vertical steps 131 are formed on side surfaces of the side surface support bodies 111a and 111b to be coupled to the vertical stopping holes 21.

In particular, the brackets 100, 100a, and 100b that are the first, second, and third support units are constituted as follows.

That is, according to the present invention, a pair of side surface support bodies 111a and 11 1 b that are integrally formed to be bent are formed at opposite ends of a central support body 110.

Further, a plurality of horizontal stopping recesses 122 and a plurality of horizontal stopping steps 121 that protrude to be fitted with the horizontal stopping holes 11 are formed on upper end horizontal surfaces 120 of the side surface support bodies 111a and 111b.

Further, according to the present invention, a plurality of vertical stopping recesses 132 and a plurality of vertical stopping steps 131 that protrude to be fitted with the vertical stopping holes 21 are formed on side vertical surfaces 130 of the side support bodies 111a and 111b.

Then, it is preferable that the horizontal surfaces 120 and the vertical surfaces 130 according to the present invention be perpendicular to each other to be firmly attached to the corners of the horizontal and vertical pipes.

Further, according to the present invention, extensions 140 and 150 protrude from opposite ends or one side surface of the central support body 110, and a horizontal coupling hole 141 and a vertical coupling hole 151 are formed in the extensions 140 and 150 such that the extensions 140 and 150 may be firmly coupled to the vertical or horizontal pipes with a coupling tool (not illustrated).

Moreover, according to the present invention, a striking recess 115 is formed in the central support body 110 so that the bracket may be driven in by a separate tool in a process of firmly assembling the bracket in the pipe.

In addition, according to the present invention, it is preferable that the striking recess 115 be a rectangular recess such that the striking tool may accurately strike the bracket without being interfered.

Meanwhile, the present invention may be variously modified and may take various forms when the elements are applied.

Further, it should be noted that the present invention is not limited to the specific forms mentioned in the detailed description of the present invention and includes all modifications and equivalents, and replacements that are within the spirit and range of the present invention, which are defined in the annexed claims.

The operational effects of the non-bolted pipe fitting bracket according to the present invention will be described as follows.

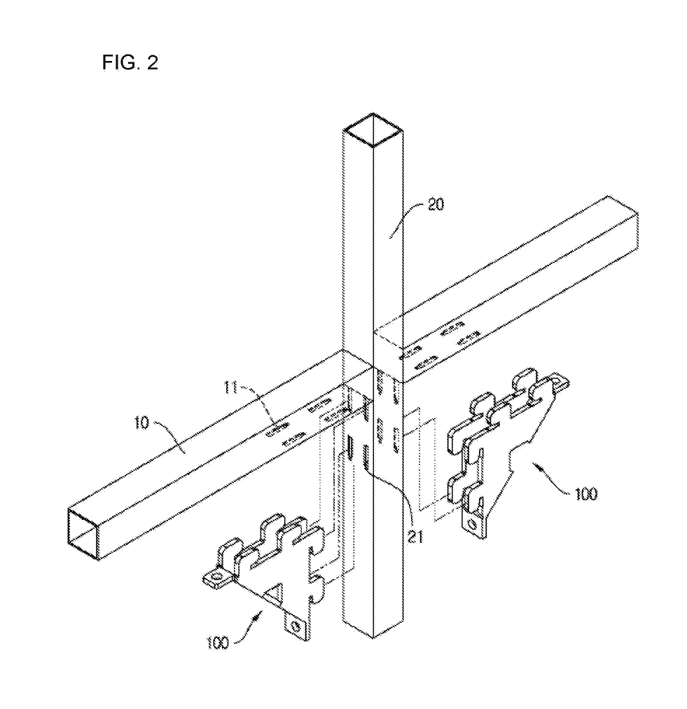

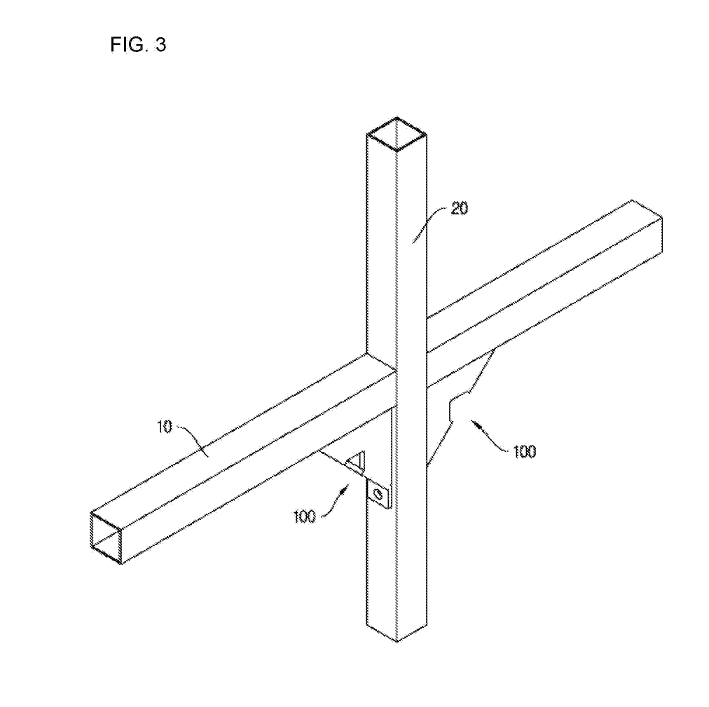

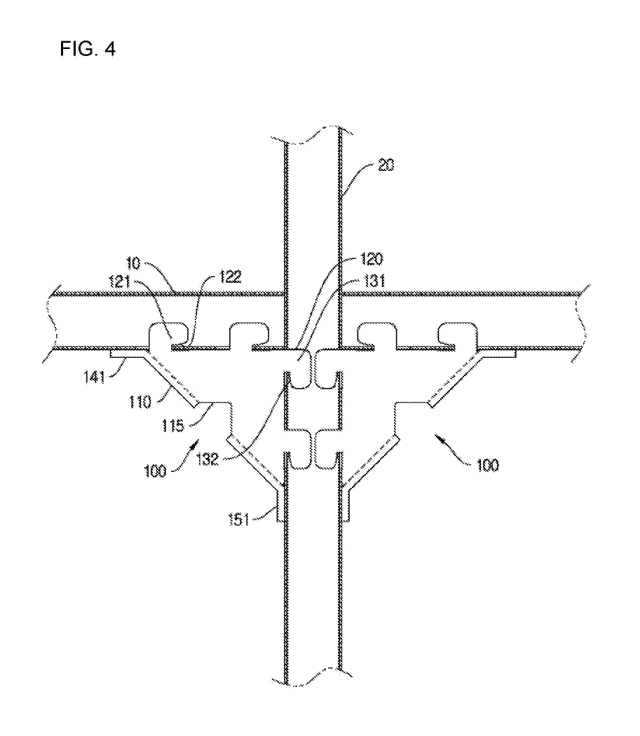

First, FIG. 1 is a perspective view of a non-bolted pipe fitting bracket 100 according to a first embodiment of the present invention, and FIG. 2 is an exploded perspective view of the non-bolted pipe fitting bracket according to the first embodiment of the present invention before the non-bolted pipe fitting bracket is coupled to a pipe. If the bracket is coupled to the pipe in this state, FIGS. 3 and 4 are obtained, and FIG. 3 is a perspective view of the non-bolted pipe fitting bracket according to the first embodiment of the present invention after the non-bolted pipe fitting bracket is coupled to the pipe and FIG. 4 is a sectional view of the non-bolted pipe fitting bracket according to the first embodiment of the present invention after the non-bolted pipe fitting bracket is coupled to the pipe.

Hereinafter, an operational effect of the first embodiment of the present invention will be described in detail.

First, the horizontal stopping steps 121 of the bracket 100 are inserted into the horizontal stopping holes 11 of the horizontal pipe 10. Thereafter, if the bracket 100 is pushed into the horizontal recesses 122, the bracket 100 is firmly fixed to the horizontal pipe 10.

Then, according to the present invention, a plurality of horizontal stopping steps 121 protrude in a pair to help the bracket 100 to be firmly fixed to the horizontal pipe 10 without being shaken to the left and right sides.

Thereafter, while the bracket 100 is coupled to the horizontal pipe 10, the vertical stopping steps 131 of the bracket 100 are inserted into the vertical stopping holes 21 of the vertical pipe 20. Thereafter, if the bracket 100 is pushed towards the vertical stopping recesses 21, that is, downwards, the bracket 100 is firmly fixed to the vertical pipe 20.

Even then, according to the present invention, a plurality of vertical stopping steps 131 protrude in a pair to help the bracket 100 to be firmly fixed to the vertical pipe 20 without being shaken to the left and right sides.

In particular, according to the present invention, if the striking recess 115 is stricken by using a striking tool (for example, a rubber hammer or a wooden hammer) in the assembling process, the bracket 100 may be easily coupled to the horizontal and vertical pipes.

Then, the striking recess 115 is a rectangular recess to help much easier assembling in order to allow the striking tool to accurately strike the striking recess 115 without being interfered.

Moreover, according to the present invention, the horizontal surfaces 120 and the vertical surfaces 130 are perpendicular to each other to firmly fix the horizontal and vertical pipes in order to firmly attach the horizontal and vertical surfaces 120 and 130 to the corners of the horizontal and vertical pipes.

In addition, according to the present invention, a horizontal extension 140 and a vertical extension 150 protrude form opposite ends of the central support body 110, and a horizontal coupling hole 141 and a vertical coupling hole 151 are formed in the extensions 140 and 150 such that the extensions 140 and 150 may be firmly coupled to the vertical or horizontal pipe with a coupling tool (not illustrated).

In particular, according to the present invention, a pair of side surface support bodies 111a and 111b that are integrally formed to be bent are formed at opposite ends of the central support body 110, which provides firmness as the bracket has a single body.

When the assembled bracket is disassembled, it may be simply separated by performing the operations in the reverse sequence.

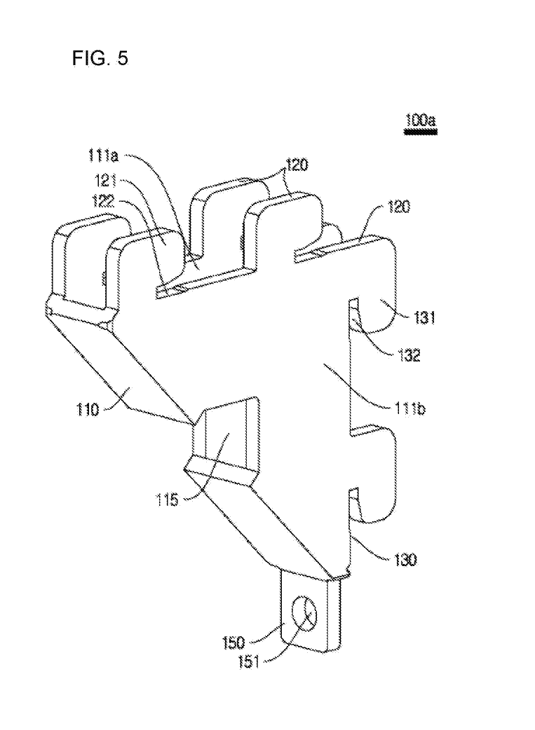

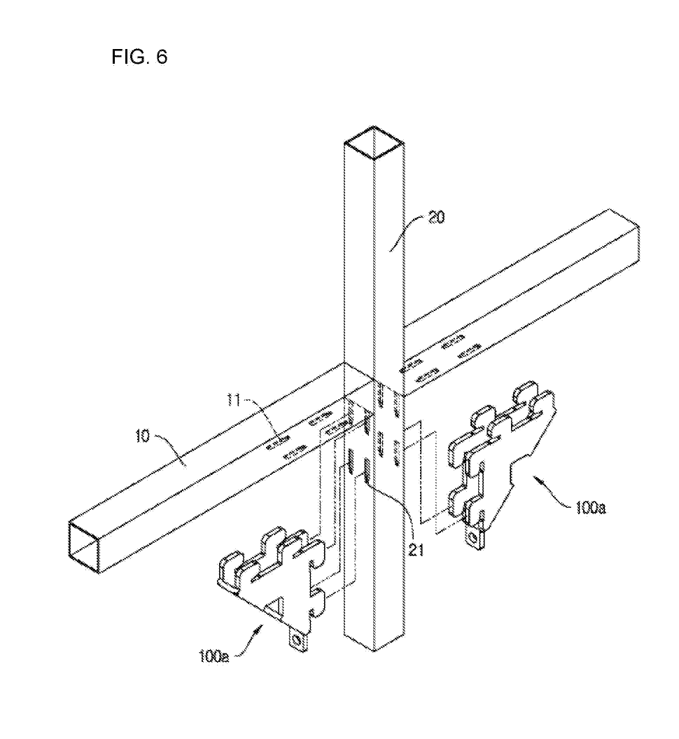

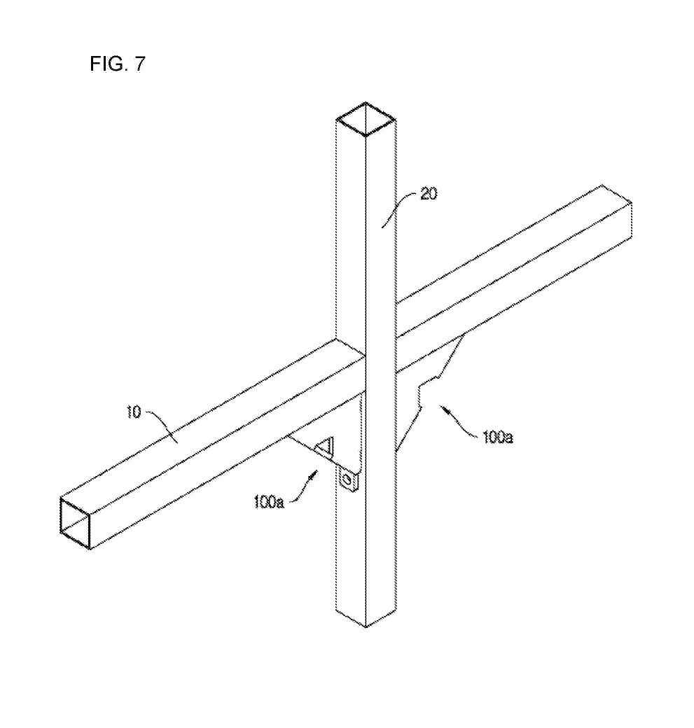

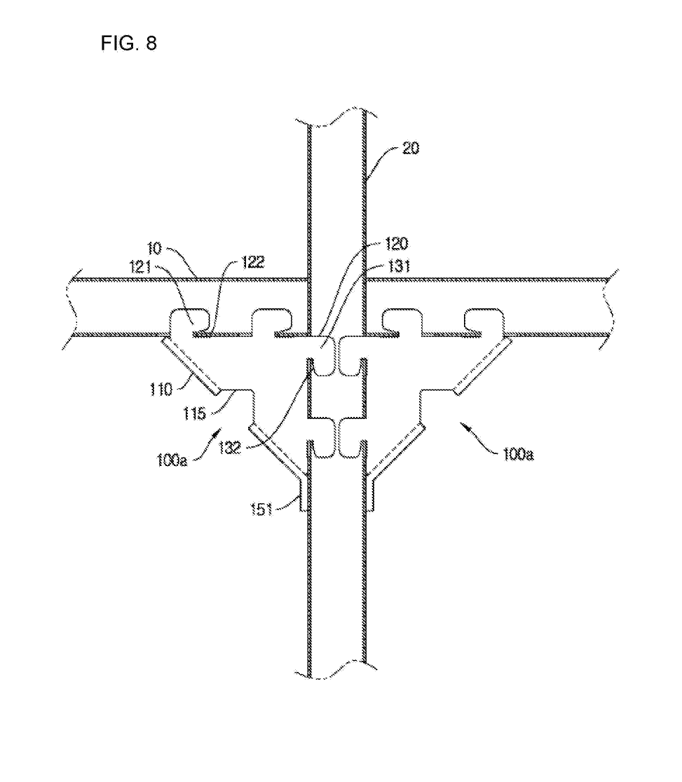

Meanwhile, FIG. 5 is a perspective view of a non-bolted pipe fitting bracket according to a second embodiment of the present invention, FIG. 6 is an exploded perspective view of the non-bolted pipe fitting bracket according to the second embodiment of the present invention before the non-bolted pipe fitting bracket is coupled to a pipe, FIG. 7 is a perspective view of the non-bolted pipe fitting bracket according to the second embodiment of the present invention after the non-bolted pipe fitting bracket is coupled to the pipe, FIG. 8 is a sectional view of the non-bolted pipe fitting bracket according to the second embodiment of the present invention after the non-bolted pipe fitting bracket is coupled to the pipe.

The second embodiment of the present invention is the same as the first embodiment of the present invention except for the horizontal extension 140 and the horizontal coupling hole 141 of the first embodiment, and the operational effects are also the same.

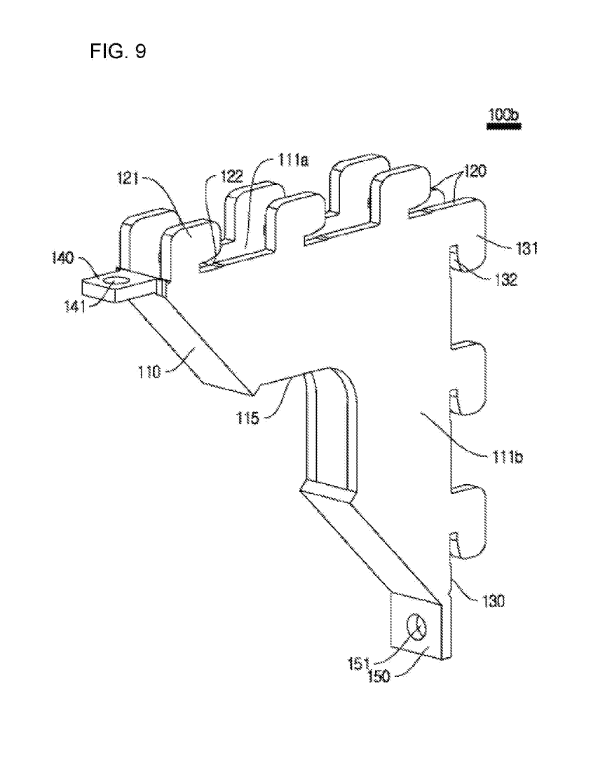

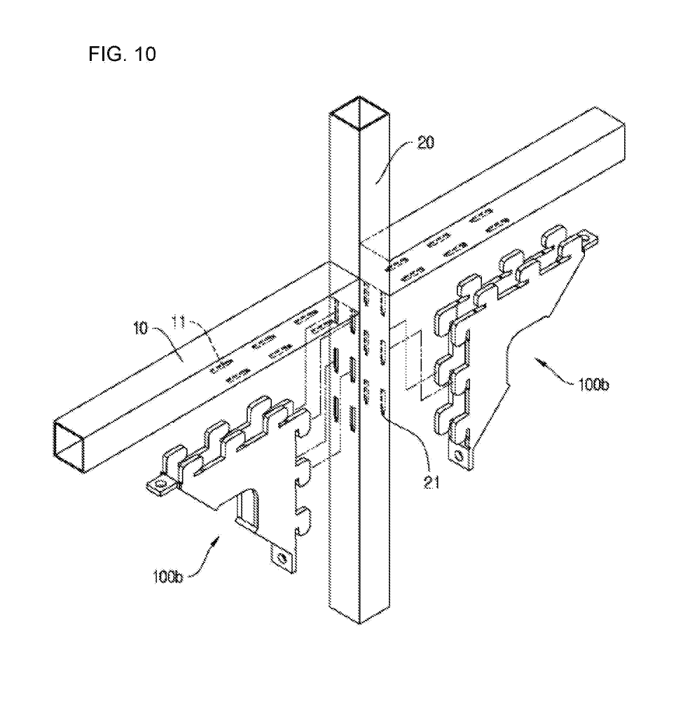

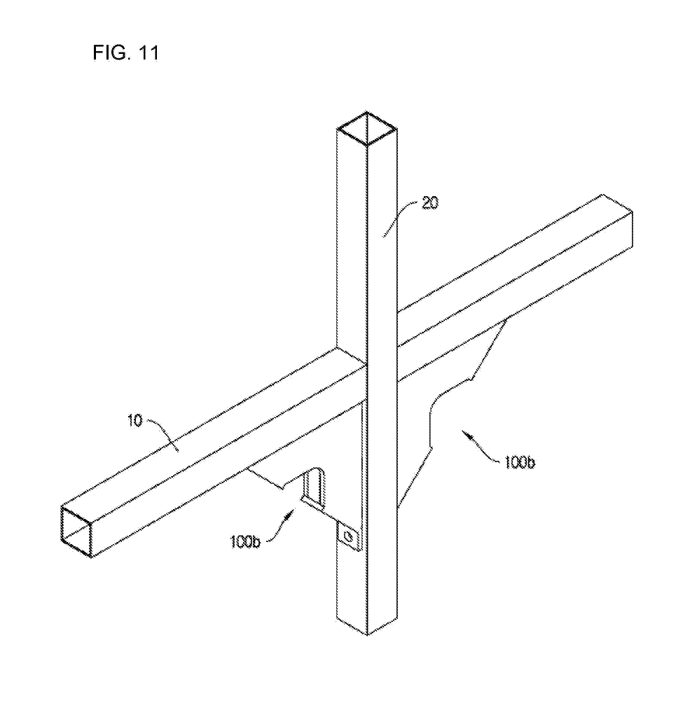

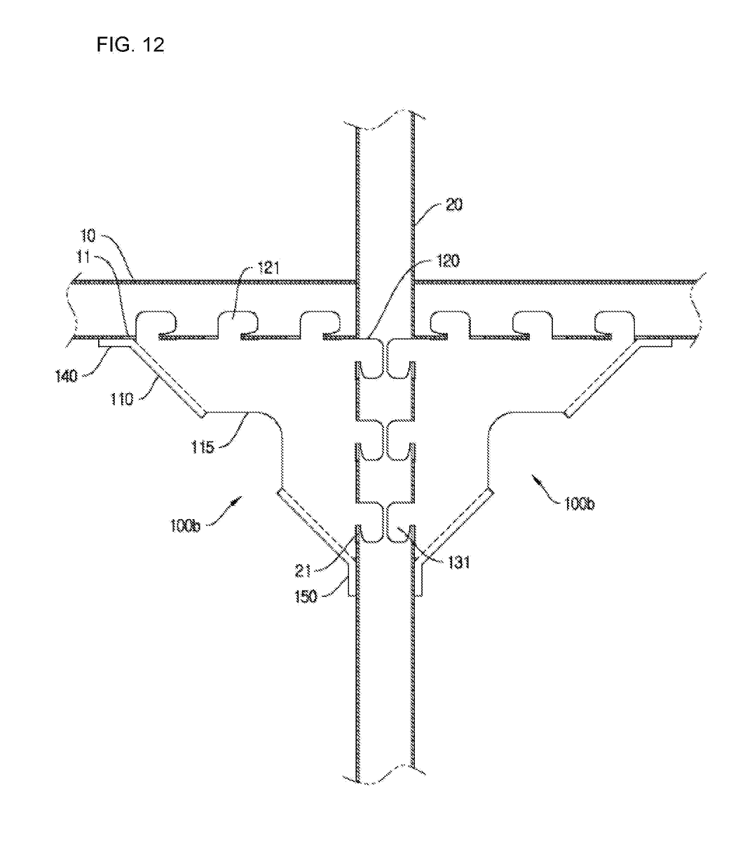

FIG. 9 is a perspective view of a non-bolted pipe fitting bracket according to a third embodiment of the present invention, FIG. 10 is an exploded perspective view of the non-bolted pipe fitting bracket according to the third embodiment of the present invention before the non-bolted pipe fitting bracket is coupled to a pipe, FIG. 11 is a perspective view of the non-bolted pipe fitting bracket according to the third embodiment of the present invention after the non-bolted pipe fitting bracket is coupled to the pipe, and FIG. 12 is a sectional view of the non-bolted pipe fitting bracket according to the third embodiment of the present invention after the non-bolted pipe fitting bracket is coupled to the pipe.

The third embodiment of the present invention is the same as the first embodiment of the present invention except that the two horizontal steps of the first embodiment are replaced by three horizontal steps, and the operational effects are also the same.

The technical spirit of the non-bolted pipe fitting bracket according to the present invention may actually repeatedly achieve the same result, and in particular, the technical development may be expedited by carrying out the present invention so that the present invention deserves to be protected as it contributes to the industrial development.

What is claimed is:

1. A non-bolted pipe fitting bracket for simply assembling an assembled pipe for displaying and preserving an article without using a bolt and a nut, the non-bolted pipe fitting bracket comprising:
a bracket that is a support unit, in which a pair of side surface support bodies are assembled at the right angle at corners of horizontal pipes each having a pair of horizontal stopping holes and a vertical pipe having a pair of vertical stopping holes, horizontal stopping steps are formed at upper ends of the side surface support bodies to be coupled to the horizontal stopping holes, and vertical stopping steps are formed on side surfaces of the side surface support bodies to be coupled to the vertical stopping holes.

2. The non-bolted pipe fitting bracket of claim 1, wherein the bracket that is the support unit comprises:
a pair of side surface support bodies integrally formed at opposite ends of a central support body to be bent;
a plurality of horizontal stopping recesses and a plurality of horizontal stopping steps protruding on horizontal surfaces of upper ends of the side surface support bodies to be inserted into horizontal stopping holes; and
a plurality of vertical stopping recesses and a plurality of vertical stopping steps protruding from vertical surfaces of the side surfaces of the side surface support bodies to be inserted into vertical stopping holes.

3. The non-bolted pipe fitting bracket of claim 2, wherein the horizontal surfaces and the vertical surfaces are perpendicular to each other to be firmly attached to the corners of the horizontal and vertical pipes.

4. The non-bolted pipe fitting bracket of claim 2, wherein extensions protrude from opposite ends of the central support body or ends of side surfaces of the central support body, and a horizontal coupling hole and a vertical coupling hole are formed in the extensions such that the extensions are firmly coupled to the vertical or horizontal pipe with a coupling tool.

5. The non-bolted pipe fitting bracket of claim 2, wherein the central support body has a striking recess into which the bracket is driven by a separate striking tool in a process of firmly assembling the bracket in a pipe.

6. The non-bolted pipe fitting bracket of claim 5, wherein the striking recess is a rectangular recess to allow the striking tool to accurately strike the striking recess without being interfered.
